(19) United States
(12) Patent Application Publication
(10) Pub. No.: US 2003/0227012 A1
(43) Pub. Date: Dec. 11, 2003

(54) Simple spare

(76) Inventor: Hector Vega, Henderson, NV (US)

Correspondence Address: Hector Vega, 2402 Predera Ave., Henderson, NV, 89052, US

(21) Appl. No.: 10/162,096

(22) Filed: Jun. 5, 2002

(51) Int. Cl. B66D 1/00

(52) U.S. Cl. 254/323

(57) ABSTRACT

This invention simplifies the process of raising and lowering a spare tire

### BRIEF DESCRIPTION OF DRAWINGS

FIG 1: Drawing of the 3 main components of the Simple Spare system.

FIG. 1 (A): Drawing of a spare tire winch that is located on the undercarriage of a vehicle (i.e. trucks, SUV's , etc.).

FIG. 1(B): Drawing of the clutch assembly located between the winch crank and the motor crank (FIG. 1(C)).

FIG. 1(C): Drawing of motor fitted with the same winch crank that comes on the original factory winch.

FIG. 2: Schematic drawing of the electrical current starting from the vehicle battery and ending with the Simple Spare motor.

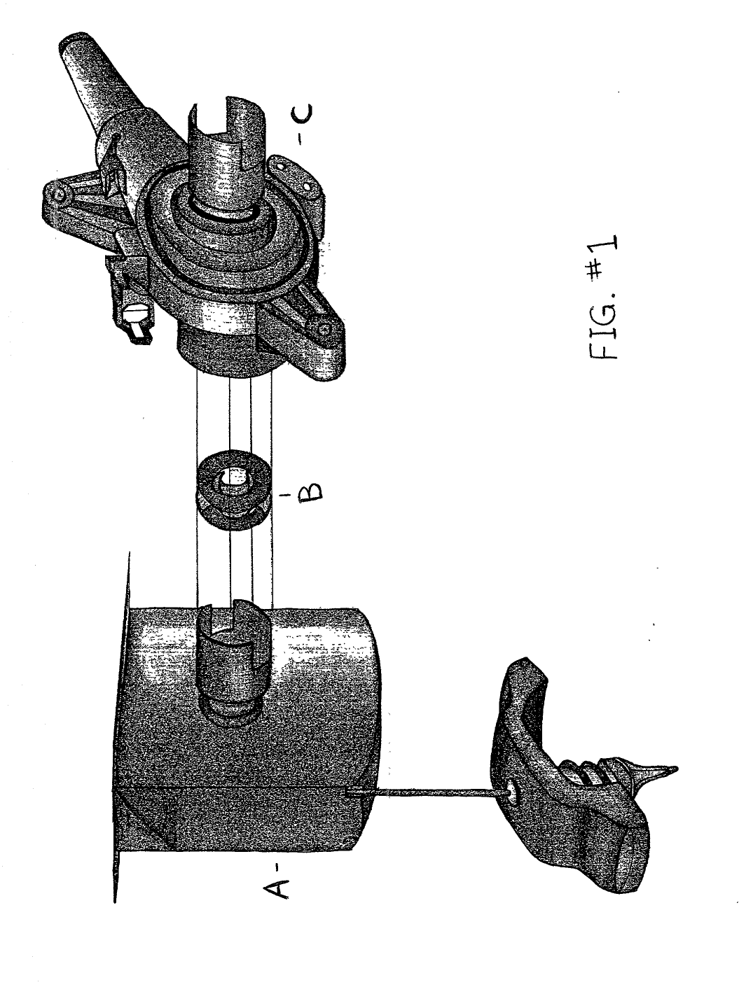

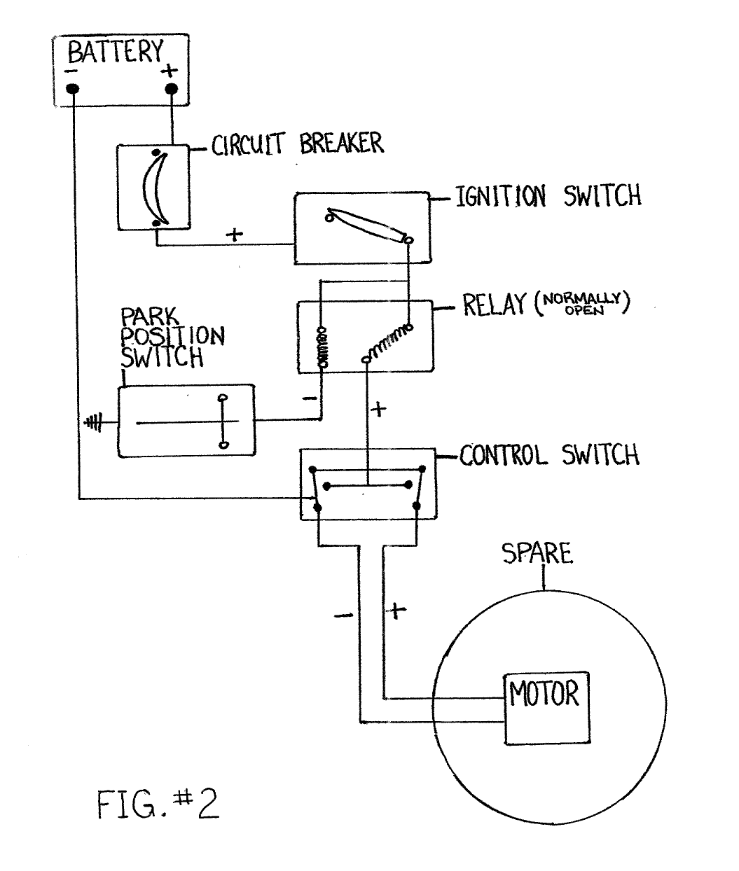

### DETAILED DESCRIPTION of INVENTION

Simple Spare

The Simple Spare was developed in order to greatly facilitate the changing of the spare tire on any vehicle that carries its spare tire underneath it. With just a touch of a button located on the instrument panel, rear cargo area or keyless remote, one can lower and raise the spare tire without having to go through the usual painstaking process we've always been forced to endure . . . until now!

How it Works

The Simple Spare is just that. Simple! The compact motorized unit is mounted right next to the existing spare tire winch. We've developed a unique clutch assembly that goes between the winch and the Simple Spare unit. This clutch prevents the user from accidentally burning out the motor should he/she keep the power button depressed in the ‘reverse’ or ‘up’ position. As the size of the tire changes, so does the size of the clutch as well as the gauge of the wire sending power to the motor. The clutch assembly also serves a second purpose. Should the motor ever fail to operate, the user can still operate the winch using the conventional ‘hand crank’ method. The motor has sufficient torque, is weather proof and requires no maintenance,

The Simple Spare is a safety conscious system. It will only operate when the vehicle is in the ‘PARK’ position on an automatic transmission or when the emergency brake is applied on a vehicle with a manual transmission. The good news is that the operator of the vehicle may choose to leave it running (with the A/C on) during use of the Simple Spare in case there are any ‘perishables’ inside that need to be kept cool.

The Simple Spare substantial reduces the amount of time you would normally take to lower and raise your spare, but more importantly it reduces your overall exposure time to traffic. It shouldn't take a lifetime to change a tire and with the Simple Spare it won't.

1. This invention is the only one of it's kind. There is nothing else like it in the market place or offered on any vehicle anywhere. I invented it to help simplify the process of changing tires. It should be patented because consumers will be able to greatly benefit from simplicity and safety it offers.
